(19) United States
(12) Patent Application Publication
(10) Pub. No.: US 2008/0288512 A1
(43) Pub. Date: Nov. 20, 2008

(54) SYSTEM AND METHOD OF EVALUATING PROGRAMMING PROCESS

(75) Inventors: Sho Huan TUNG, Yunlin (TW); Tsung Teh LIN, Yunlin (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: NATIONAL YUNLIN UNIVERSITY OF SCIENCE AND TECHNOLOGY, Yunlin (TW)

(21) Appl. No.: 12/044,567

(22) Filed: Mar. 7, 2008

(30) Foreign Application Priority Data
May 16, 2007 (TW) 0961117462

(51) Int. Cl. G06F 9/44; G06F 17/30

(52) U.S. Cl. 707/100; 717/124; 707/E17.044

(57) ABSTRACT

The invention provides a system and a method for evaluating a programming process. The programming evaluating system includes a programming module, a determining module, a recording module, and an evaluating module. A user can program a program via the programming module. The determining module is used for determining whether the program has passed a test to generate a determination. The recording module is used for recording a programming history during the programming process of the user and a program testing history during the testing process of the program. When an evaluator wants an evaluated result of the program, the evaluating module generates the evaluated result based on the programming history, the program testing history, and the determination.

### CROSS-REFERENCE TO RELATED APPLICATIONS

This non-provisional application claims priority under 35 U.S.C. §119(a) on Patent Application No(s). 0961117462 filed in Taiwan, R.O.C. on May 16, 2007, the entire contents of which are hereby incorporated by reference.

### BACKGROUND OF THE INVENTION

1. Field of the Invention

This invention relates to a system and method for evaluation, and more particularly, to a system and method for evaluating a programming process. Please refer to the related technical literature and websites listed below:

[1] Anderson, J. R., and Skwarecki, E. (1985) “The automated tutoring of introductory computer programming”, Communications of the ACM, Vol. 29, No. 9, pp. 842-849, 1985

[2] Brusilovsky, P., Schwarz, E., & Weber, G. (1996) ELM-ART: An intelligent tutoring system on World Wide Web. In Frasson, C., Gauthier, G., & Lesgold, A. (Ed.), Intelligent Tutoring Systems (Lecture Notes in Computer Science, Vol. 1086). Berlin: Springer Verlag. 261-269.

[3] Chang, K. E., Chiao, B. C., Chen, S. W., & Hsiao, R. S. (2000) A Programming Learning System for Beginners—A Completion Strategy Approach. IEEE Transaction on Education, Vol. 43, No. 2, 211-220.

[4] Garcia, A., Rodriguez, S., Rosales, F. & Pedraza, J. L. (2005) Automatic Management of Laboratory Work in Mass Computer Engineering Courses. IEEE Transactions on Education, Vol. 48, No. 1, 89-98.

[5] Johnson, W. L. & Soloway, E. (1987) PROUST: An automatic debugger for Pascal programs, in Artificial Intelligence & Instruction: Applications and Methods, G. P. Kearsley, Ed. Menlo Park, Calif.

[6] Joy, M. & Luck, M. (1999) Plagiarism in Programming Assignments, IEEE Transactions on Education, Vol. 42, No. 2, 129-133.

[7] http ://www.turingscraft.com

[8] http ://theory.stanford.edu/˜aiken/moss/

[9] https ://www.ipd.uni-karlsruhe.de/jplag/

2. Description of the Prior Art

In the teaching of programming, a teacher who adopts one-way teaching usually cannot know well about the learning state of learners, so it is hard for the teacher to advise the learners at the right moment, or to properly adjust the teaching progress. Compared with the traditional one-way teaching approach, the interactive teaching approach not only can satisfy the needs of teachers' instruction and learners' response but also can improve learners' interest and efficiency in learning. Nowadays many teaching systems in support of interactive programming learning have been developed. The teaching systems recorded in references [1], [3], and [5] can support individual learners to carry out debugging during interactive learning. The teaching systems recorded in references [2] and [7] can assist multiple learners to interactively debug via the Internet. Systems in support of multiple learners usually can provide teachers information about whether learners has begun to practice programming assignments, whether the programs developed by the learners can pass the test, or a currently occurred testing error of a learner. However, all of the teaching systems neglect to record and analyze error records, pressed keystroke records, occurred times, or other data generated while learners practice programming by themselves without assistance of the systems. However, the error records, the pressed keystroke records, the occurred times, or other data are able to provide teachers information about whether the learners' learning process are abnormal, the learners have excellent learning capability, or learning disability or not.

In addition, programming courses have been plagued by the problem of plagiarism in programming assignments for a long time. This problem facilitates a lot of software which can detect whether program assignments are involved in plagiarism to be developed. However, the software is designed based upon comparing accomplished programs to see whether the programs are similar or not. Namely, there is no software developed based upon recording data such as the error records, the pressed keystroke records, the times of beginning to program and passing the test to analyze and to provide information of suspects involved in plagiarism during learners' programming activities.

Accordingly, in order to solve the above-mentioned problems, the invention provides a system and a method of evaluating programming process. The system and the method not only allow learners to practice programming in a proper programming environment, but also allow the instructors to obtain learners' complete programming and testing history, provide proper guidance to the learners, and prevent the occurrence of plagiarism.

### SUMMARY OF THE INVENTION

An embodiment according to the invention is a programming evaluating system. The programming evaluating system includes a programming module, a determining module, a recording module, and an evaluating module. A user is capable of programming a program via the programming module. The determining module is used for determining whether the program has passed a test to generate a determination. If the determination is YES, the determining module informs the user that the program has passed the test. If the determination is NO, the determination module informs the user that the program has not passed the test and suggests the user keeping on programming/modifying the program via the programming module. The recording module is used for recording a programming history during the process of programming of the user, and for recording a program testing history during the process of determining whether the program has passed the test. When an evaluator wants an evaluated result of the program, the evaluating module generates the evaluated result based on the programming history and the program testing history. The evaluated result includes a suspected probability of being involved in plagiarizing and a ranking from excellent to bad.

The advantage and spirit of the invention may be understood by the following recitations together with the appended drawings.

### BRIEF DESCRIPTION OF THE APPENDED DRAWINGS

FIG. 1 is a function block illustrating a programming evaluating system according to a first embodiment of the invention.

FIG. 2 is a flow chart showing a programming evaluating method according to a second embodiment of the invention.

FIG. 3 is a function block illustrating a programming evaluating system according to a third embodiment of the invention.

FIG. 4 is a flow chart showing a programming evaluating method according to a fourth embodiment of the invention.

### DETAILED DESCRIPTION OF THE INVENTION

The scope of the invention is to provide a system and method for evaluating a programming process. The system and the method support learners to practice programming in a programming environment, allow the instructors to obtain learners' complete programming and testing history, provide proper guidance to the learners, and prevent the occurrence of plagiarism.

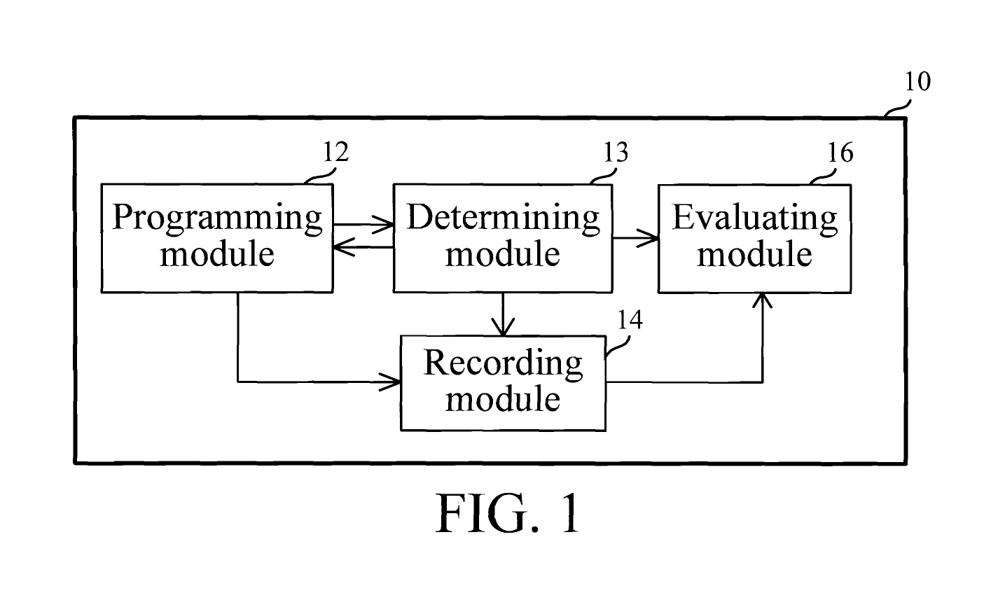

A first embodiment according to the invention is a programming evaluating system. Please refer to FIG. 1. FIG. 1 is a function block illustrating the programming evaluating system 10. As shown in FIG. 1, the programming evaluating system 10 includes a programming module 12, a determining module 13, a recording module 14, and an evaluating module 16. A user is capable of programming a program via the programming module 12. The determining module 13 is used for determining whether the program has passed a test to generate a determination. If the determination is YES, the determining module 13 informs the user that the program has passed the test. If the determination is NO, the determination module informs the user that the program has not passed the test and suggests the user keeping on programming/modifying the program via the programming module 12. The recording module 14 is used for recording a programming history during the process of programming of the user, and for recording a program testing history during the process of determining whether the program has passed the test. When an evaluator wants an evaluated result of the program, the evaluating module 16 generates the evaluated result based on the programming history and the program testing history. The evaluated result generated by the evaluating module 16 includes a suspected probability of being involved in plagiarizing and a ranking from excellent to bad.

In a practical application, the programming evaluating system 10 can be embedded in an Internet Server. The user is capable of using the programming evaluating system 10 via the Internet. The programming module 12 is capable of being displayed in a web browser, or being downloaded to a personal computer or a notebook via the Internet. The user can program in various different programming languages (such as Java, C, C++, or JSP) by the programming module 12. The programming history can include all related information while the user is programming. The related information can be, for instance, a starting time of programming, a sequence and timings of pressing keys, a using frequency of pressing special keys and a number of program linage. The program testing history can include related information during the test of the program. The related information can be, for instance, testing error messages, a number of times of failed test, or a time of passing the test. A spending time of programming can be obtained by subtracting the time of passing the test from the starting time of programming. In addition, the foregoing special keys can include an arrow key (i.e. up arrow key, down arrow key, left arrow key, and right arrow key), a delete key, or a control key.

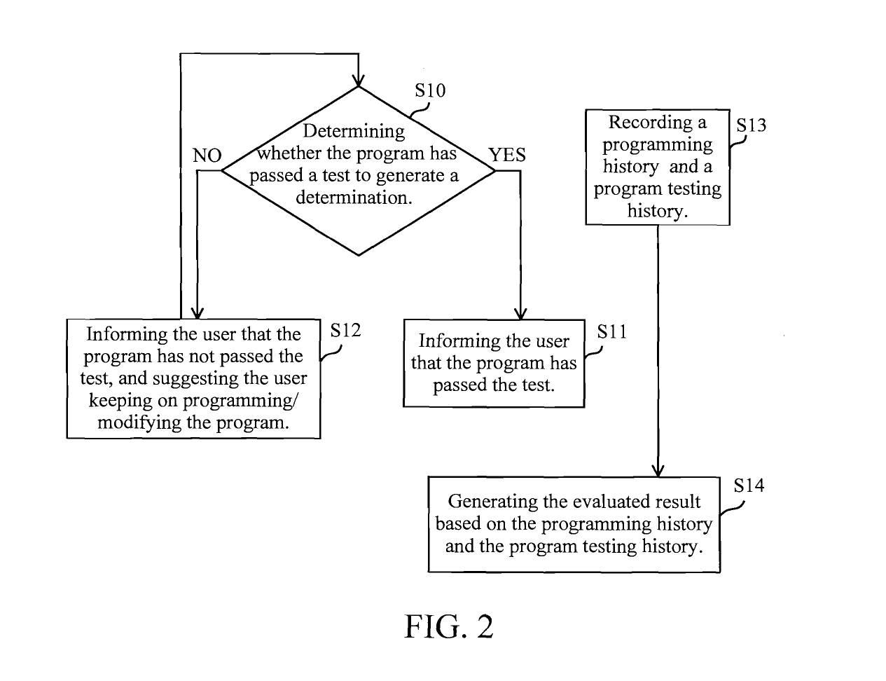

A second embodiment according to the invention is a programming evaluating method. Please refer to FIG. 2. FIG. 2 is a flow chart showing the programming evaluating method. As shown in FIG. 2, the method includes step S10: determining whether the program has passed a test to generate a determination after a user programs a program. If the determination generated by step S10 is YES, the method adopts step S11: informing the user that the program has passed the test. If the determination generated by step S10 is NO, the method adopts step S12: informing the user that the program has not passed the test, suggesting the user keeping on programming/modifying the program, and repeating step S10. In the same time, the method adopts step S13: recording a programming history during the process of programming of the user and a program testing history during the process of determining whether the program has passed the test. When an evaluator wants an evaluated result of the program, the method adopts step S14: generating the evaluated result based on the programming history and the program testing history. The evaluated result includes a suspected probability of being involved in plagiarizing and a ranking from excellent to bad.

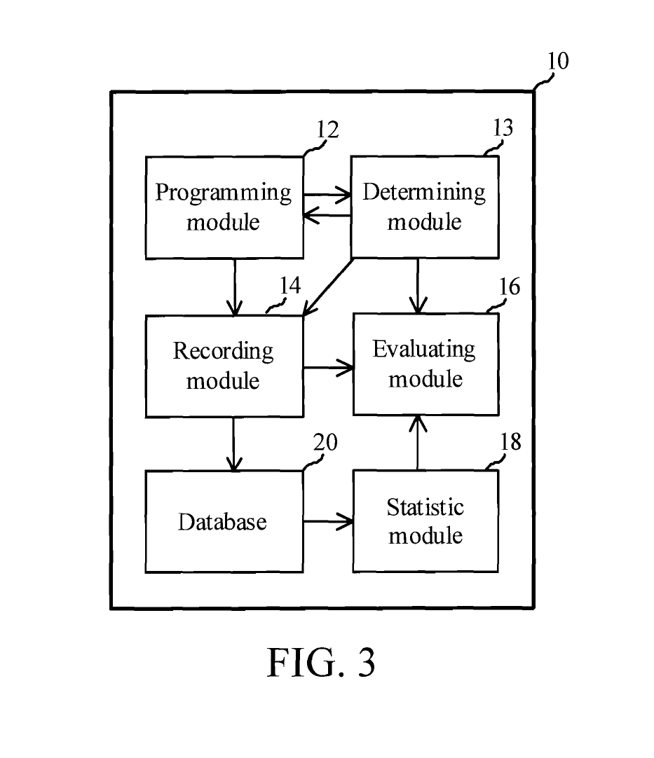

A third embodiment according to the invention is a programming evaluating system 10. Please refer to FIG. 3. FIG. 3 is a function block illustrating the programming evaluating system 10. In the embodiment, except a programming module 12, a determining module 13, a recording module 14, and an evaluating module 16, the programming evaluating system 10 further includes a database 20 and a statistics module 18. After recording the programming history and the program testing history, the recording module 14 uploads the programming history and the program testing history to the database 20. The database 20 is used for storing the programming history and the program testing history. In practice, if there is more than one user, the database 20 is able to store the programming histories and the program testing histories of all users. The statistic module is connected to the database 20 and is used for providing a statistic result. The statistic result can be obtained by compiling statistics of programming histories and program testing histories of all users stored in the database 20.

In an practical application, the statistic result can includes related information of programming of a user, such as a range of normal using numbers of keys, a range of deficient using numbers of keys, a range of excess using numbers of keys, a range of normal using numbers of special keys, a range of deficient using numbers of special keys, a range of excess using numbers of special keys, a range of normal numbers of not passing the test, a range of deficient numbers of not passing the test, a range of excess numbers of not passing the test, a range of normal program linage, a range of deficient program linage, a range of excess program linage, a range of normal times of passing the test, a range of early times of passing the test, a range of late times of passing the test, a range of normal times of spending, a range of less times of spending, or a range of excess times of spending.

Afterward, when the evaluator wants the evaluated result of the program, the evaluating module 16 can generate the evaluated result by comparing the programming history, the program testing history, and the statistic result. That is to say, the evaluating module 16 can be based on whether the data of the user is within the foregoing ranges of the statistic result to generate the evaluated result by comparing an item of the programming history or the program testing history with the range of the statistic result of the item in the database 20. For instance, if the spending time of a certain learner is within the range of less times of spending, the using number of keys of the learner is within the range of normal using numbers of keys, and the time of passing the test of the learner is within the range of early times of passing the test, it represents that the learner finishes the program fast and spends less time, and the level of the learner may be above average. On another hand, if the number of not passing the test of a certain learner is within the range of deficient numbers of not passing the test, the spending time of the learner is within the range of less times of spending, and the using number of keys of the learner is within the range of deficient using numbers of keys, it represents that the learner may finish the homework by copying the program of another person. The teacher can know well about the individual learning history of each user and the whole learning status of each user of a class by the compared results of many items.

Moreover, the programming evaluating system 10 can further include a display module (not shown in figures). The display module is used for displaying the evaluated result generated by the evaluating module 16.

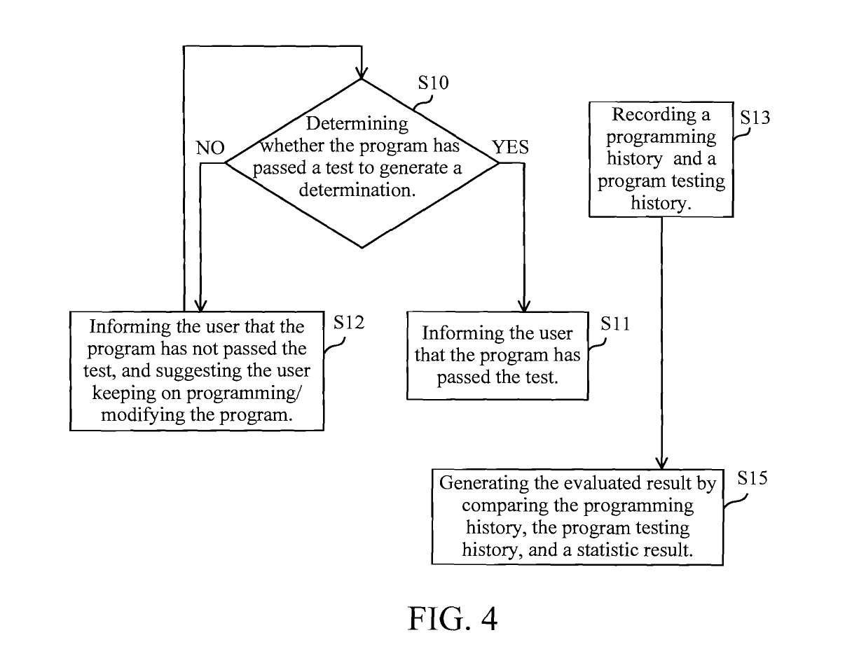

A fourth embodiment according to the invention is a programming evaluating method. Please refer to FIG. 4. FIG. 4 is a flow chart showing the programming evaluating method. As shown in FIG. 4, the method includes step S10: determining whether the program has passed a test to generate a determination after a user programs a program. If the determination generated by step S10 is YES, the method adopts step S11: informing the user that the program has passed the test. However, if the determination generated by step S10 is NO, the method adopts step S12: informing the user that the program has not passed the test, suggesting the user keeping on programming/modifying the program, and repeating step S10. Besides, the method includes step S13: recording a programming history during the process of programming of the user and a program testing history during the process of determining whether the program has passed the test. When an evaluator wants an evaluated result of the program, the method adopts step S15: generating the evaluated result based on the programming history, the program testing history, and a statistic result. The evaluated result includes a suspected probability of being involved in plagiarizing and a ranking from excellent to bad. In practice, the statistic result can be derived by compiling statistics of the programming histories and the program testing histories of many users. For instance, a statistic result can be derived by compiling statistics of the programming histories and the program testing histories of all students in a programming course. Furthermore, the programming evaluating method can further include the step of displaying the evaluated result (not shown in figures).

Compared with the prior art, the system and the method for evaluating a programming process according to the invention not only show the functions that prior arts already had such as whether a learner has begun to practice the programming assignment, whether the program of the learner has pass the test or the testing error message that the user currently encounters, but also allow the learner to develop the capability of programming by proceeding programming practice in a proper programming environment. At the same time, the system and the method still can allow teachers to monitor complete programming/testing histories of learners and know well about the learning progress and learning disability to provide the learners proper guidance and prevent the learners from plagiarism. Moreover, the programming evaluating system not only supports synchronous practice in computer room, but also provides asynchronous practice over the Internet to allow students to program exercises before class at home and review after class. Absentees can also make up missed exercises in their free time to catch up with other classmates.

Actually, there are no limits of the number of users allowed to operate the programming evaluating system provided by the invention. It can be one or more than one. For instance, if there are 50 students taking a certain course, each student can connect to the system over the Internet by themselves and prepare for lessons of this week before class. When the teacher teaches over the system in class, the students can practice programming immediately at the same time. The teacher can realize that whether the students all comprehend the context in the class right away, enhance the teaching to students whose learning progress fall behind, and find out the students who have excellent potential of programming and give them higher level of practice. After class, the student can also do programming assignments. With the assistance of the system, the teacher can monitor students' programming histories of practicing assignments clearly. As long as a student is suspected of involving in plagiarizing, the system will make a comparison automatically and also make a mark. Therefore the occurrence of plagiarism among students can be prevented.

With the example and explanations above, the features and spirits of the invention will be hopefully well described. Those skilled in the art will readily observe that numerous modifications and alterations of the device may be made while retaining the features and spirit of the invention. Accordingly, the above disclosure should be construed as limited only by the metes and bounds of the appended claims.

What is claimed is:

1. A programming evaluating system comprising:
a programming module, a user being capable of programming a program via the programming module;
a determining module, connected to the programming module, for determining whether the program has passed a test to generate a determination, if the determination is YES, the determining module informing the user that the program has passed the test, and if the determination is NO, the determination module informing the user that the program has not passed the test and suggesting the user keeping on programming/modifying the program via the programming module;
a recording module, connected to the programming module and the determining module, for recording a programming history during the process of programming of the user, and recording a program testing history during the process of determining whether the program has passed the test; and
an evaluating module, connected to the determining module and the recording module, when an evaluator wants an evaluated result of the program, the evaluating module generates the evaluated result based on the programming history and the program testing history, the evaluated result comprising a suspected probability of being involved in plagiarizing and a ranking from excellent to bad.

2. The programming evaluating system of claim 1, wherein the programming evaluating system is embedded in an Internet Server, and the user uses the programming evaluating system via the Internet.

3. The programming evaluating system of claim 1, wherein the programming module is displayed in a web browser, or is downloaded to a personal computer or a notebook via the Internet.

4. The programming evaluating system of claim 1, wherein the programming history comprises a starting time of programming, a sequence and timings of using keys, a using frequency of a key, a using frequency of a special key and a number of program linage, the program testing history comprises a testing error message, a number of times of not passing the test, a time of passing the test or a spending time of programming obtained by subtracting the time of passing the test from the starting time of programming.

5. The programming evaluating system of claim 1, further comprising:
a database, connected to the recording module, for storing the programming history and the program testing history uploaded by the recording module.

6. The programming evaluating system of claim 5, further comprising:
a statistics module, connected to the database, providing a statistic result, when the evaluator wants an evaluated result of the program, the evaluating module generates the evaluated result by comparing the programming history, the program testing history, and the statistic result.

7. The programming evaluating system of claim 6, wherein the statistic result comprises a range of normal using numbers of keys, a range of deficient using numbers of keys, a range of excess using numbers of keys, a range of normal using numbers of special keys, a range of deficient using numbers of special keys, a range of excess using numbers of special keys, a range of normal numbers of times of not passing the test, a range of deficient numbers of times of not passing the test, a range of excess numbers of times of not passing the test, a range of normal program linage, a range of deficient program linage, a range of excess program linage, a range of normal times of passing the test, a range of early times of passing the test, a range of late times of passing the test, a range of normal times of spending, a range of less times of spending, or a range of excess times of spending.

8. The programming evaluating system of claim 1, further comprising:
a display module, connected to the evaluating module, for displaying the evaluated result.

9. A programming evaluating method comprising the steps of:
(a) determining whether the program has passed a test to generate a determination after a user programs a program;
(b) if the determination is YES, informing the user that the program has passed the test;
(c) if the determination is NO, informing the user that the program has not passed the test, suggesting the user keeping on programming/modifying the program, and repeating step (a);
(d) recording a programming history during the process of programming of the user and a program testing history during the process of determining whether the program has passed the test; and
(e) generating the evaluated result based on the programming history and the program testing history when an evaluator wants an evaluated result of the program, the evaluated result comprising a suspected probability of being involved in plagiarizing and a ranking from excellent to bad.

10. The programming evaluating method of claim 9, wherein the programming history comprises a starting time of programming, a sequence and timings of using keys, a using frequency of a key, a using frequency of a special key and a number of program linage, the program testing history comprises a testing error message, a number of times of not passing the test, a time of passing the test or a spending time of programming obtained by subtracting the time of passing the test from the starting time of programming.

11. The programming evaluating method of claim 9, wherein the evaluated result in the step (c) is generated by comparing the programming history, the program testing history, and a statistic result.

12. The programming evaluating method of claim 11, wherein the statistic result comprises a range of normal using numbers of keys, a range of deficient using numbers of keys, a range of excess using numbers of keys, a range of normal using numbers of special keys, a range of deficient using numbers of special keys, a range of excess using numbers of special keys, a range of normal numbers of times of not passing the test, a range of deficient numbers of times of not passing the test, a range of excess numbers of times of not passing the test, a range of normal program linage, a range of deficient program linage, a range of excess program linage, a range of normal times of passing the test, a range of early times of passing the test, a range of late times of passing the test, a range of normal times of spending, a range of less times of spending, or a range of excess times of spending.

13. The programming evaluating method of claim 9, further comprising the step of:
(f) displaying the evaluated result.
